(19) United States
(12) Patent Application Publication
(10) Pub. No.: US 2015/0106902 A1
(43) Pub. Date: Apr. 16, 2015

(54) GLOBAL SHARING NETWORK SYSTEM

(71) Applicants: Alfredo MIRAGLIA, Legnano (Milano) (IT); Davide Orazio DE COLA, Arcore (Monza-Brianza) (IT); Alessandro LEONE, Milano (IT); Matteo COGLIATI, Arese (Milano) (IT); Liliana VIGANO, Arese (Milano) (IT)

(72) Inventors: Alfredo MIRAGLIA, Legnano (Milano) (IT); Davide Orazio DE COLA, Arcore (Monza-Brianza) (IT); Alessandro LEONE, Milano (IT); Matteo COGLIATI, Arese (Milano) (IT); Liliana VIGANO, Arese (Milano) (IT)

(21) Appl. No.: 14/052,077

(22) Filed: Oct. 11, 2013

(51) Int. Cl. H04L 29/06

(52) U.S. Cl. CPC H04L 63/0815; H04L 63/10
USPC 726/8

(57) ABSTRACT

A unifying and automated access and archiving method and system that permits unification, in one single login procedure, access to all networks and Web portals, and, at the same time, automatic downloading of relevant documents made available in the Web, i.e., by suppliers and Public Administration. The method and system allows creation of a home archive to store all documents, data and contents of interest, both captured from the sources at Web portals and from sharing actions with other users. Documents are organized and stored on the basis of predefined logical criteria so being stored and made available for prompt research and eventual sharing.

### FIELD OF THE INVENTION

The object of the invention is a global sharing network aimed at simplifying information and documents access, sharing and archiving through a creation of a unique and personalized Web application.

The current invention refers a social network apt to manage and to share contents and documents from different sources. Beyond the social functionalities, this application can be considered as an enterprise content management solution.

### BACKGROUND OF THE INVENTION

Today the search of Web Sites, Web contents, relevant information related to personal documents issued or published by suppliers and/or Public Administration has reached a high level of complexity: high number of passwords to be memorized, fragmentation of info sources, large number of different Web accounts, all start making life difficult instead of more simple.

In the prior art, the user must login and logout each time he wants to verify an invoice issued by each of his suppliers (mobile phone, Internet provider, highways services, TV broadcast), a payment done to Public Administration (taxes, fines, etc.) or to search for a document related to his citizen status (certificates, pension, medical insurance, etc.).

In the prior art, the user is obliged to log in separately to interact with others users belonging to different Social Networks (professional environment on Linkedin, sharing private or professional documents on Drop Box, chatting with friends on Facebook, sharing photos and videos on Flirck, phone calls on Skype, etc.).

Another limitation of actual document search systems is that documents are not automatically organised and archived in a unique home file system.

In addition, today Company Networks are generally “closed” within the Company environment and communication to and from private clients and/or other Companies are difficult because of need to adopt different delivery methods (e-mails, notification, publication on Company Web Site, etc.).

The present invention discloses a novel Unifying Network system to allow a unique Web Access, a unique information and documents container which automatically actively searches for relevant documents and ensure their organisation and archiving and a new interaction model between Companies and consumers.

### SUMMARY OF THE INVENTION

Single authentication procedure. It is an object of the present invention to provide a novel scheme by which all the above described limitations are overcome to enable a unique access gate to Web contents allowing a user to log in only once (only one access secure procedure) to enter all Social and Company Networks for which user had set access permissions through a guided procedure.

This possibility is due to the present inventive method and system that execute, on computer hardware, particular algorithms that register the access procedure and execute the access procedure automatically each time the log in is required.

Password generation: it is an object of the invention to provide a method and system where a computing device executes an automatic algorithm that allows creation and updating, on a scheduled time base, of new passwords for all memorized accesses. These new passwords will be automatically stored within a storage device in the single authentication procedure of function above described.

Automatic document capturing: it is an object of the present invention to enable automatic capturing of defined documents (i.e. invoices) from Source (i.e. suppliers Companies) Web Portal on a pre-defined time scheduling and their automatic indexing and archiving. The captured documents are stored on a document storage device and may be marked for sharing with other users.

The invention will propose some predefined sources (most common utilities companies country by country), but, of course, the invention will allow the user to personally select or create his own sources.

This is the central element of the invention, an innovative system that memorizes a particular procedure executed manually once and allows the computing system (a dedicated scraping Software tool) to repeat the memorized procedure automatically each time the procedure is required by the set scheduling.

Immediately after capturing, the incoming document is automatically classified (tagged) and archived in a document storage device.

The system allows the user to let the automatic computing system collect, index and archive relevant documents in his stead leaving anyhow the choice to execute the entire procedure or single parts of it manually.

Another particularity is that each user can use procedures already set by other users for the same source.

Monitoring and warning: it is an object of the invention to allow the user to be warned when some settled conditions are verified (for example, when the bill of a Utility Company is higher than a settled amount of money predefined by the user).

The System, through an OCR engine and a text element recognition, detects the figures and/or data, and, through precise algorithms, determines their matching to predefined rules.

The invention further provides a document storage device, so that at the end of this check phase, the document is automatically archived or, in case of not matching, put in evidence to the user.

Automatic document sharing: it is an object of the invention to allow the user to automatically share the documents with other users or groups of users (i.e. all invoices with fiscal advisor).

All features of the social networks: it is an object of this invention to permit the user to benefit, in addition to all above described functions, of all features already proposed by existing Social Networks (i.e. chatting, sharing of photos, music, videos, VOIP, videoconference, agenda, etc.).

This possibility will be allowed in two different ways, letting the user to choose the favourite one:
adopting the functionalities of the invention (solution 1); and
selecting the preferred Social Network among a selection made by the invention on the basis of precise criteria (i.e. selection of most known Networks specialised in photos sharing in case of user intention to share holidays photos with friends) (solution 2).

The invention will offer its own “social” functionalities, but it is prepared to make a selection of other existing Networks on the base of some specialisation criteria, also presenting sales conditions comparison.

When solution 2 is preferred, the invention will detect the format of the relevant content and/or action (i.e. photos and/or chatting) and it will make a screening of the related Networks available in the Web, proposing them to the user. After the choice, the invention will permit the easy connection to the selected Network.

The invention will satisfy common needs of “social functionalities” acting in this specific field as a “generalist”, anyhow concentrating major part of normal use. It means that in a long term prospective the common use of the invention will circumscribe the access to specialised networks only in case of very specific technical requirements (i.e. aesthetic retouching of photos or semi-professional video editing or wide teleconferencing).

Interactive communication channel it is an object of the invention to facilitate the documents flow to and from clients integrating actual Company Document Management System (if applied).

In the prior art, Company issue, e.g., the invoice through internal ERP and make it available to client in different ways:
postal service;
e-mail notification with attached documents (i.e. invoice); and
mail notification to recommend access to the Company Web Portal.

This is a unidirectional communication flow, not allowing immediate answers or comments, moreover not immediately archive able in the Company File System.

The invention is aimed to promote the communication to and from clients/suppliers through the invention, so dramatically reducing the need of traditional delivery systems (cost reduction) and, at the same time, to facilitate feedbacks from the clients/suppliers.

All this gives the possibility to keep open a direct communication channel with clients (in reality opened by the client having decided to let his personal invention tool to capture relevant documents from the Web Company Portal), exploiting it to promptly react to their requirements/needs, moreover allowing the archiving of all clients feedbacks in the internal Company DMS and to treat and analyse massive lots of data (Big Data) to arrange of precious information about satisfaction, awareness, etc.

If so, all kind of enquiries, researches, etc. become easy and extremely cheap.

So, when the Company accepts to open a direct communication channel with its clients already registered in the invention platform, it access to a wide range of functionalities going from the direct sharing of documents (invoices, but also questionnaires, sales proposals, acceptance investigations, etc.) up to all kind of statistics related to business personalization (tailoring).

Legal archiving procedure it is an object of the invention to permit Companies to treat digitally also all documents having fiscal and or law relevance (e.g. contracts signed with advanced digital signature) through dedicated Hardware/Software tools and to allow cryptography procedures of files through specific algorithms.

To summarize, the invention will meet the needs both of private and business users. Each of the two user categories will present a “social” environment and a “work” environment.

For a private user, the social environment will be friends, family, hobbies (sharing pictures, movies, chats, music, reading); the “work” environment will be home documents, communications with public administration, payments, bills, fines, medical reports, fiscal documents and so on.

For companies, institutions, Associations, the social environment will be the relationship with the customers, associates, affiliates, employees, the customer satisfaction analysis, direct marketing actions, market researches; the “work” environment will be the traditional document management systems, above all the document publication to the external network.

According to the present invention, with only one login, the user will be able to access to all Social Networks with a unique key: with only one password to be memorized, the invention will automatically link the user to Networks of his interest.

First page of the invention shows a view of all Social Networks logos, possibility to select the ones of interest, identification procedure one by one just the first time.

At successive log in at the invention, the first page will show the logos of selected Networks and the login to each of them will be automatically done.

Strong limitation of security level of actual system based on passwords is due to the general adoption of very common passwords, moreover very rarely updated. The invention will permit the automatic generation of new passwords, on predefined time scheduling (i.e. once a day, once a month), thanks to an algorithm that, for every application of user interest, “builds” a sequence of alphanumeric digits, fulfilling security recommendations.

The invention will automatically retrieve invoices or other documents issued by suppliers (i.e. Utility Companies) and/or by Public Administration (PA) on a predefined time scheduling capturing them from the suppliers web portal.

The user, through a guided procedure, will manually execute the standard procedure requested by each source just once and a scraper tool will memorize it, so being capable, successive times, to repeat it itself.

First page of this specific chapter of the invention will show a kind of table where the user will be asked to digit manually, only the first time, all suppliers and or PA of his interest.

At this stage, the invention will automatically show, as examples, some major brands selected on the base of different criteria: Market share and/or commercial agreements already signed with the invention.

As further step, the invention will ask to the user to set identification procedure and type of document of his interest, brand by brand. As already said, the scraper tool will memorize the identification procedure and it will repeat it automatically.

The document is now automatically tagged and archived in the invention, creating in this way the personal central pool of documents.

Documents are organised, archived and easily accessible.

Incoming documents are automatically archived, but, if desired, the invention can execute specific action flows to check matching of predefined figures and/or data with set values and alert the user in case of discordance.

The warning value will be set when brand/type of document are set as previously disclosed.

In case of warning, a pop up will be displayed proposing different action: archive anyhow, send a request of more info to the source, save the document in a separate archive area named “to do list”, make an automatic comparison of the invoiced amount i.e., Year Ending versus Year Ending-1.

The invention permits to eventually share some/all incoming documents with some other users.

List of sharing users will be set at stage above disclosed and referred to the automatic retrieving of invoices and/or other documents, if routinely automatic sharing is required. In alternative, the invention will allow to manually share selected documents.

The invention is basically a Social Network, so including all standard functionalities of most diffused Networks: chatting, contents/documents sharing, social board, agenda, calendars, etc.

The first page of this chapter will show the list of available contacts. By selecting the wished one, it appears a dedicated mask proposing the possible actions (functionalities). By selecting the wished action (i.e. share agenda), it appears the dedicated mask.

The invention allows the user to select wished functionality also from other Networks.

When the shared user is selected, it appears, together with the list of possible actions, also a list of other Networks grouped by main functionality (i.e. Facebook, Linkedin, etc.).

The invention will show also a summary of the sales condition applied by each proposed Network.

Some routines of the invention keep updated a data base where the relevant information are collected from the Networks web sites.

The invention allows the sources of various incoming documents to exploit the communication channel open by the user.

The source interested in this process can send an invitation to all its contacts (i.e. clients and/or suppliers) to share in the invention relevant documents, so avoiding need for the user to actively capture documents by scraper tool. In this case, a real communication bi-directional channel is open, allowing flow of documents from the source to the client and parallel flow of contents (i.e. messages) from the client to the source.

There is also the possibility, for the source, to address this flow of contents to the internal DMS (data management systems), if present.

If this feature is required, a human intervention of technicians is needed.

The bi-directional flow of documents and contents can, of course, involve also questionnaires, market researches, etc. All generated data are memorized in a dedicated area of the invention and can be processed to get statistical info by a Big Data processor of the invention.

The documents flows from/to clients and/or suppliers involve also documents having fiscal or legal relevance. In these cases, the invention allows to digitally sign the relevant documents, so giving them legal validity (according to the specific laws of different countries).

This is a further facilitation of the communication flows avoiding the need to deliver by mail printed documents when official signature is required. Moreover, all legal documents can automatically archived fulfilling the Country fiscal and legal rules on the basis of a predefined time scheduling (i.e. once a month, once a year, etc.).

### BRIEF DESCRIPTION OF THE DRAWINGS

The accompanying drawings, being incorporated in and forming a part of this specification, illustrate embodiments of the invention and, together with the description serve to explain the principles of the present invention.

FIG. 1 shows a flow-chart illustrating the sequence of operation of the login procedure;

FIG. 2 shows a flow-chart representing the sequence of operations and procedures of the global sharing network system of the present invention;

FIG. 2A shows a legenda for understanding the flow-chart of FIG. 2;

FIG. 3 shows a first portion of a flow-chart illustrating a sequence of operations for a specific procedure given as an example (the “invoice managing process”);

FIG. 3A shows a second portion of the flow-chart of previous FIG. 3;

FIG. 4 shows the dashboard;

FIG. 5 shows the scraping tool;

FIG. 6 shows workflow setting; and

FIG. 7 shows indexing and archiving of scanned or digital documents.

### DETAILED DESCRIPTION OF THE INVENTION

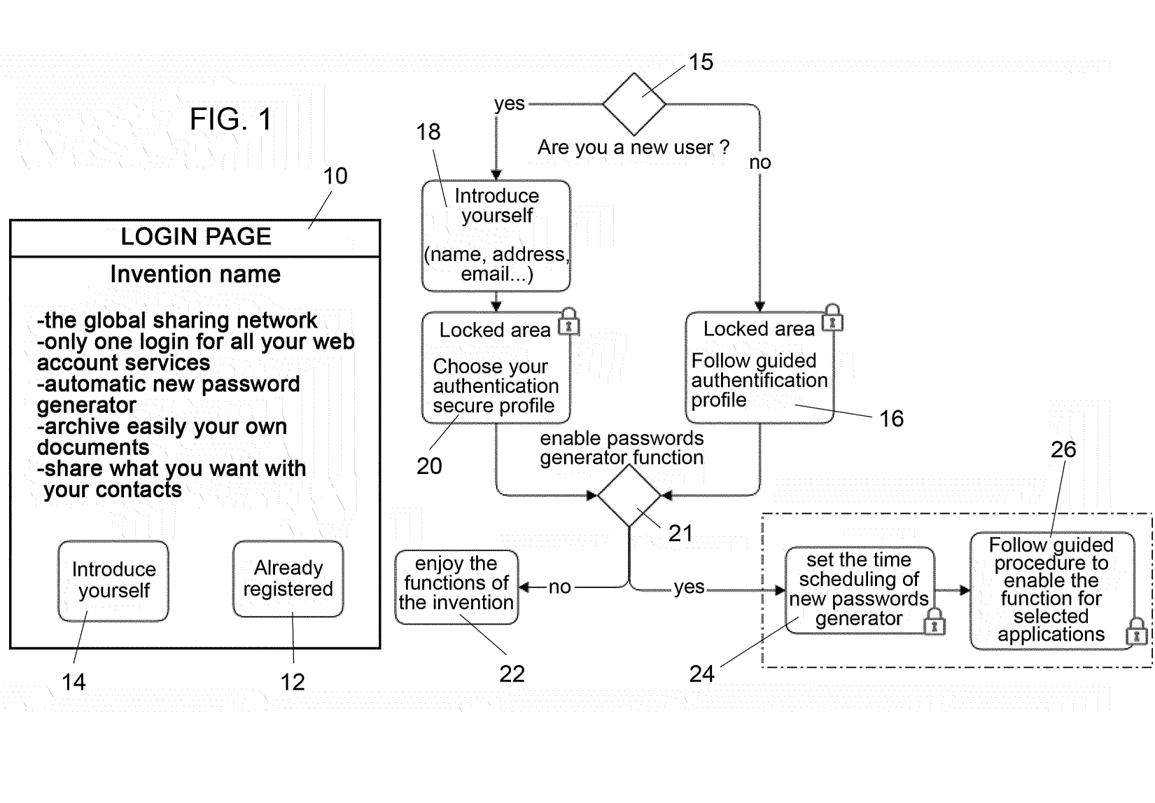

Referring to figures, first page drawing (FIG. 1) shows invention name and key features (block 10) executed by the inventive device. On a display a first screen with two enter options are provided, on the basis of authentication status: i) already registered (12) or ii) new user or “introduce yourself” (14).

In case of a registered user (considering the decision block 15), the computing device, executing the inventive method, will present on the display a secure or locked area (16) and requires a precise authentication procedure that will be required each time to ensure the maximum privacy protection.

In case of new user, the invention will guide the user through an identification procedure to prevent identity theft (blocks 18 and 20).

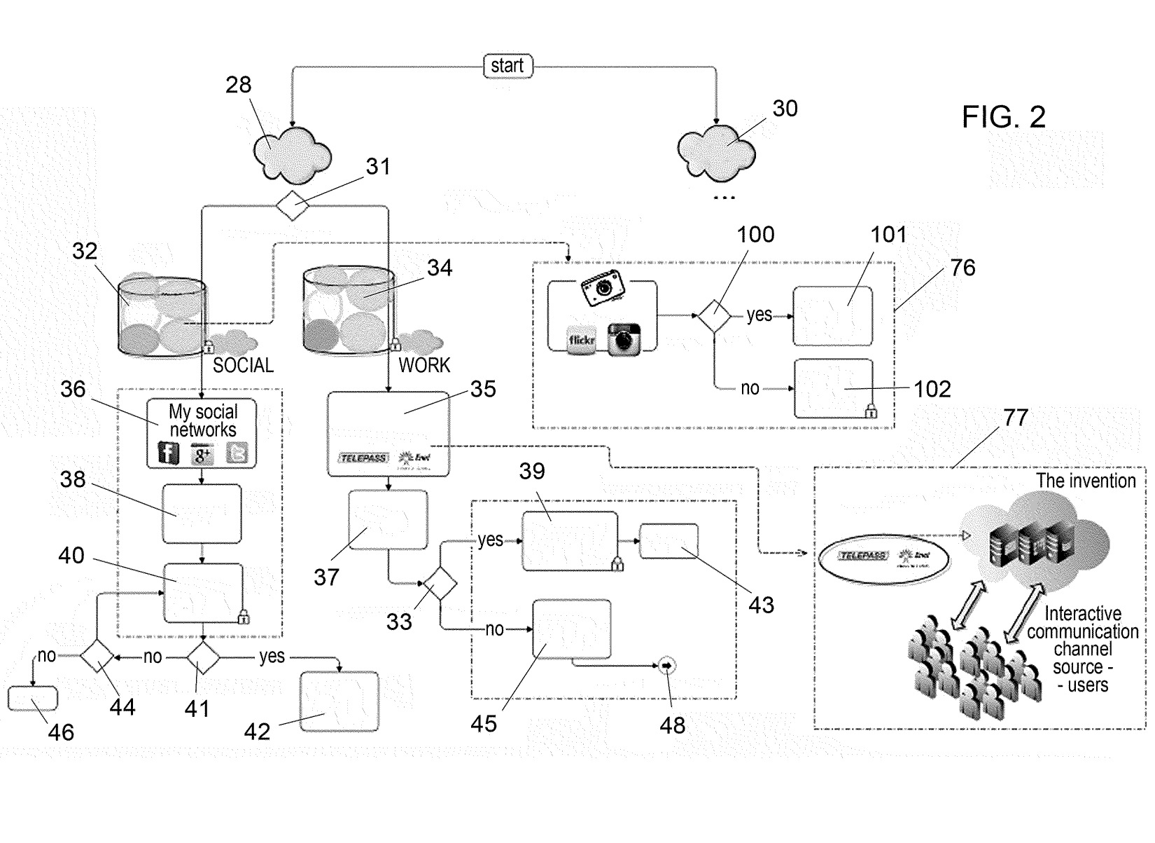

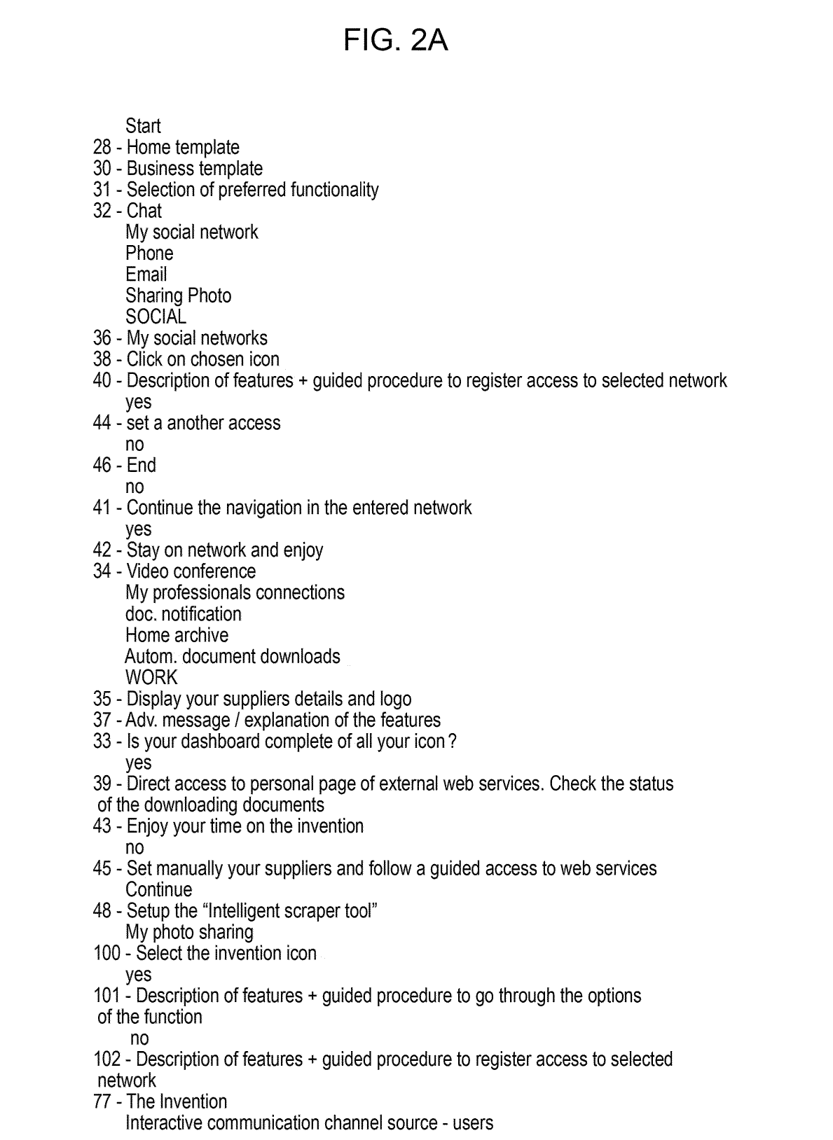

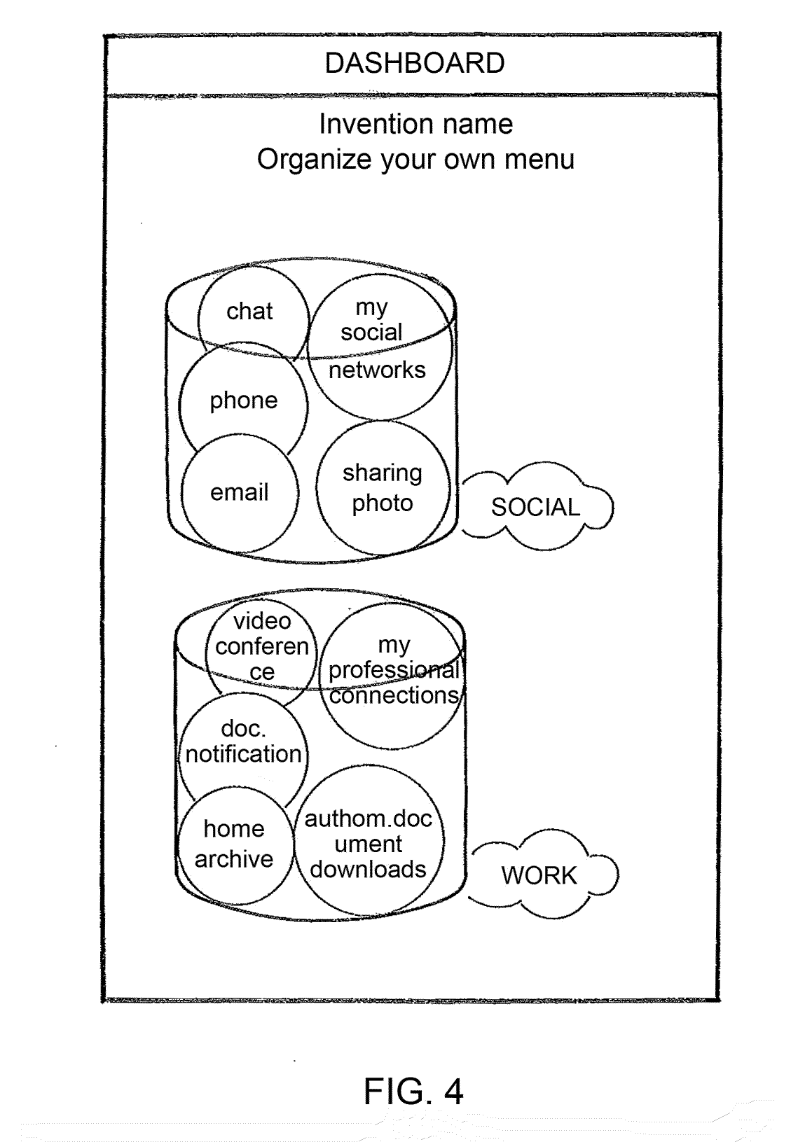

Referring to FIGS. 2 and 2A, so far as second page is concerned, the user is requested to choose in which environment he wants to operate: “Home” (28) or “Business” (30), well distinguished by two different graphical styles. Each of two environments will propose two “containers” (the user has to choose which one of the two (block 31)), one referred to “social functions” (32) and the other to “works functions” (34) (in FIG. 2 just the two containers of “home” environment are illustrated). The user will also have the possibility to personalize the dashboard by clicking on icons of functions of his interest (FIG. 4).

During the authentication procedure and or memorization of access procedures, the user will have the possibility to enable the passwords generator function (blocks 22, 24 and 26 of FIG. 1).

This complexity is highly compensated by the possibility to “memorize” later access procedure to social networks, web portals, email account. The invention will be greatly appreciated by all users who are interested to benefit of a unique login procedure to enter all social network, web applications of interest and to automatically download documents of interest from web sites of relevant suppliers/public administration.

By selecting, for example “my social network” (36) function, the invention will display logos of most diffused social networks (i.e. on the basis of worldwide market share and/or commercial agreement signed with the invention). By clicking (38) on favourite icon (“click on chosen icon”), the invention will display the description of the function and will guide the user along the standard registering procedure (40). This procedure will be memorized by the invention, so it will be executed automatically in occasion of successive accesses.

After the registering procedure (40) the user can decide (block 41) if continuing the navigation in the entered network (42), setting another access (44) or ending the navigation/procedure (46).

Referring to the FIG. 2, it is shown the main feature of the invention.

The user, considering the block (34), can display the supplier's details and logos (block 35), see the advertising messages and the features explanation (block 37)and decide (block 33)if the dashboard is completed with all the icons needed).

If the answer is “yes”, then there is a direct access (block 39) to the personal pages of external web services and a checking-in of the status of the downloaded document and the user can enjoy his time on the invention (block 43).

If the answer is “no”, the user has to set manually the suppliers and follow a guided access to web services (block 45) and setup an intelligent scraping tool (block 48).

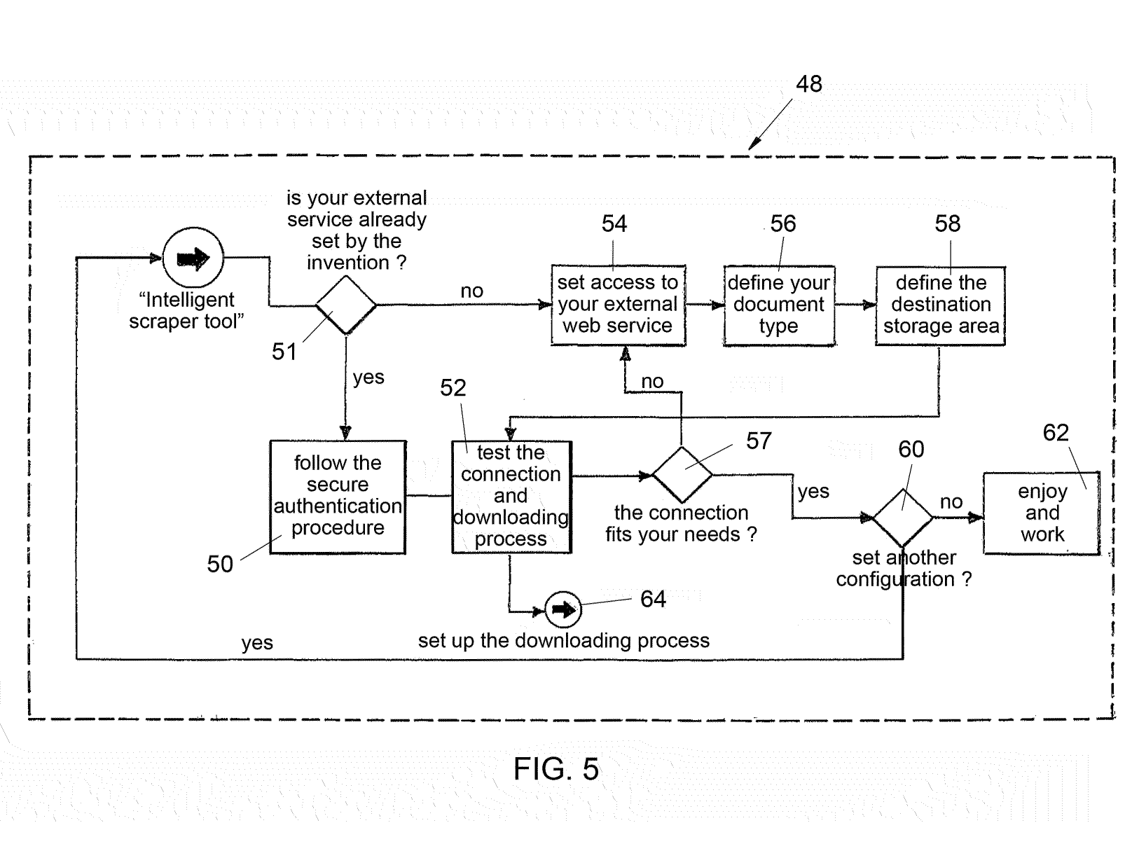

The intelligent scraping tools (48) allow the user to create and manage a private and public document archive (FIG. 5).

This is the main goal of the invention. The user through the scraping tool (48; FIG. 2) and the functionality of the invention, can perform (if the external services are already set by the invention—decision block 51) secure authentication procedure (50) which allows to test the connection and the downloading process (52) and can have access to all his-her contents in a unique central pool of documents.

According the procedure of the scraping tool, the user can verify if the external service is already set by the invention (blocks (50) and (52)) or not (blocks (54), (56) and (58)).

In fact, if the external service is not set by the invention, said invention sets the access to the user's external web service (54), defines the user's document type (56) and the destination storage area (58) and, then, the procedure continues according to block (52), that is with the testing of the connection and the downloading process.

More specifically, the invention shows to the user predefined connections to different external web services and web portals (i.e. mobile account service or TV broadcast account) on the basis of worldwide market share, commercial agreement signed with the invention, or public connections defined by other users of the invention.

Though these connections the user can add content to his-her private archive downloading document of his interest (i.e. invoices, certificates, payments). The user (if the connection fits the user's needs (decision block 57)) through a guided procedure can set a new connection (block 60) or test a predefined one (block 52). The invention save the authentication credentials of any connections by high level of security protection and storage. This feature gives to the invention proof of stable and secure central authentication interface by which he can access to all own web services (entertainment and business) (block 62). The intelligent scraping tool is able to “learn and find the way” to downloadable contents of a web services. The user only needs to define the document type and sharing rules of the contents and document downloaded.

In the business sphere of the invention the user can archive and share documents (as later disclosed) with his contacts. A dashboard shows the status of the documents: downloaded, shared or still to be processed. Other useful features are available in this business area to manage content and get in touch with contacts.

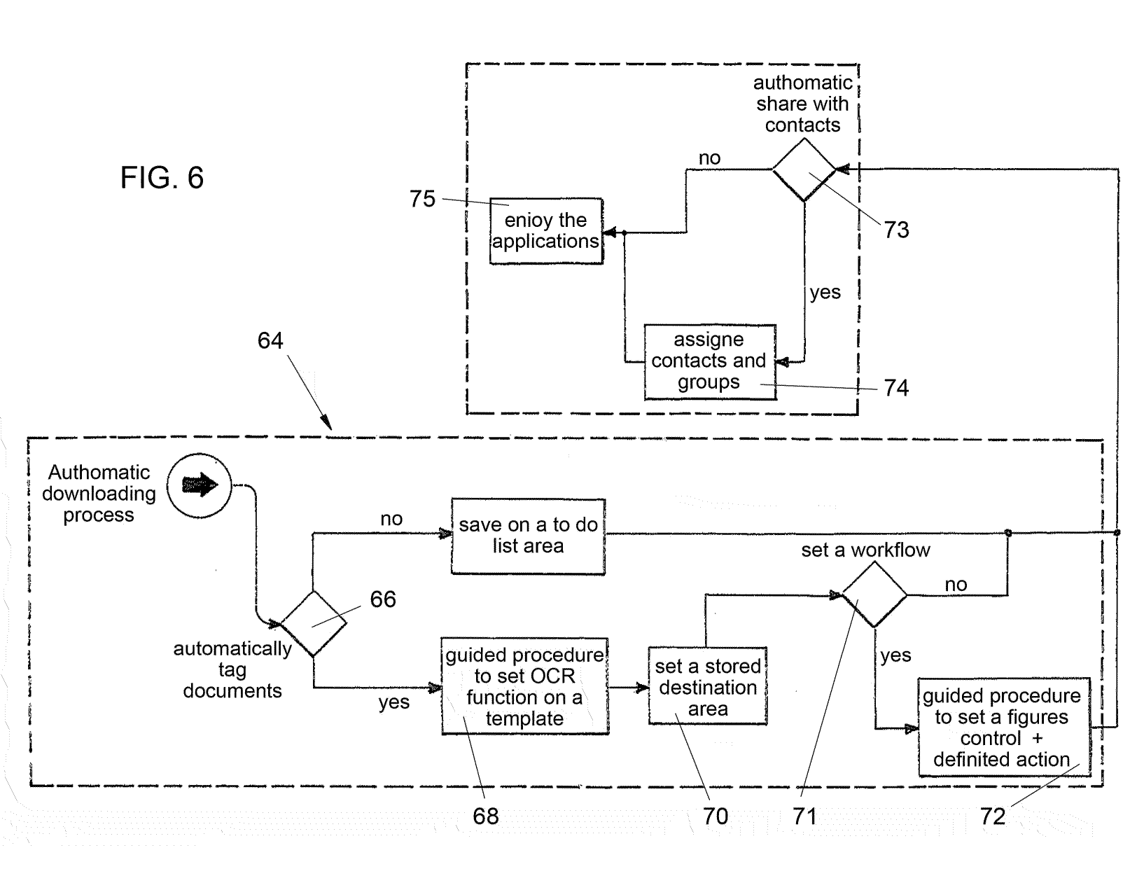

Referring to FIGS. 5 and 6, the downloading process (block 64) starts automatically on predefined scheduled time thanks to an OCR system that can “recognize” the document type and its contents.

More in particular, it is possible to choose (block 66) to automatically tag the documents or not.

If the user decides for the automatic tag, a guided procedure (block 68) to set OCR function will start and a stored destination area for the document will be set (block 70).

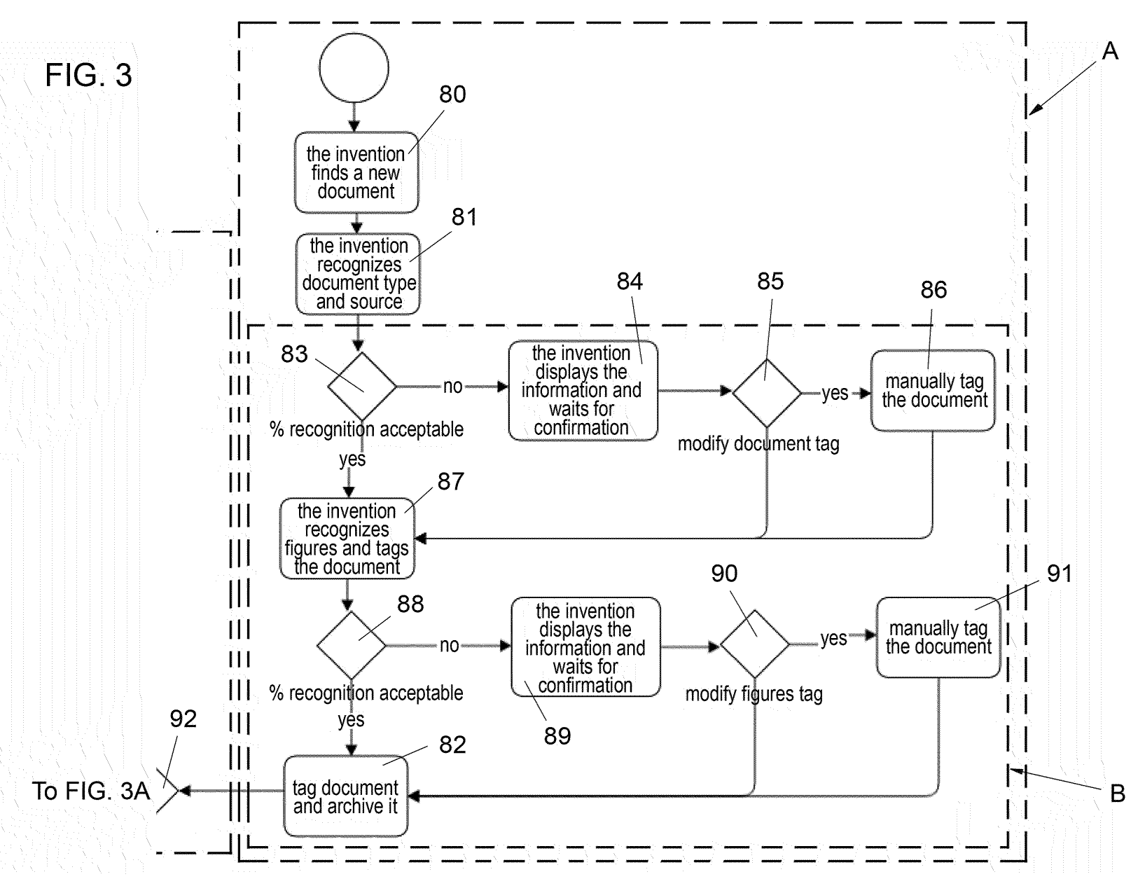

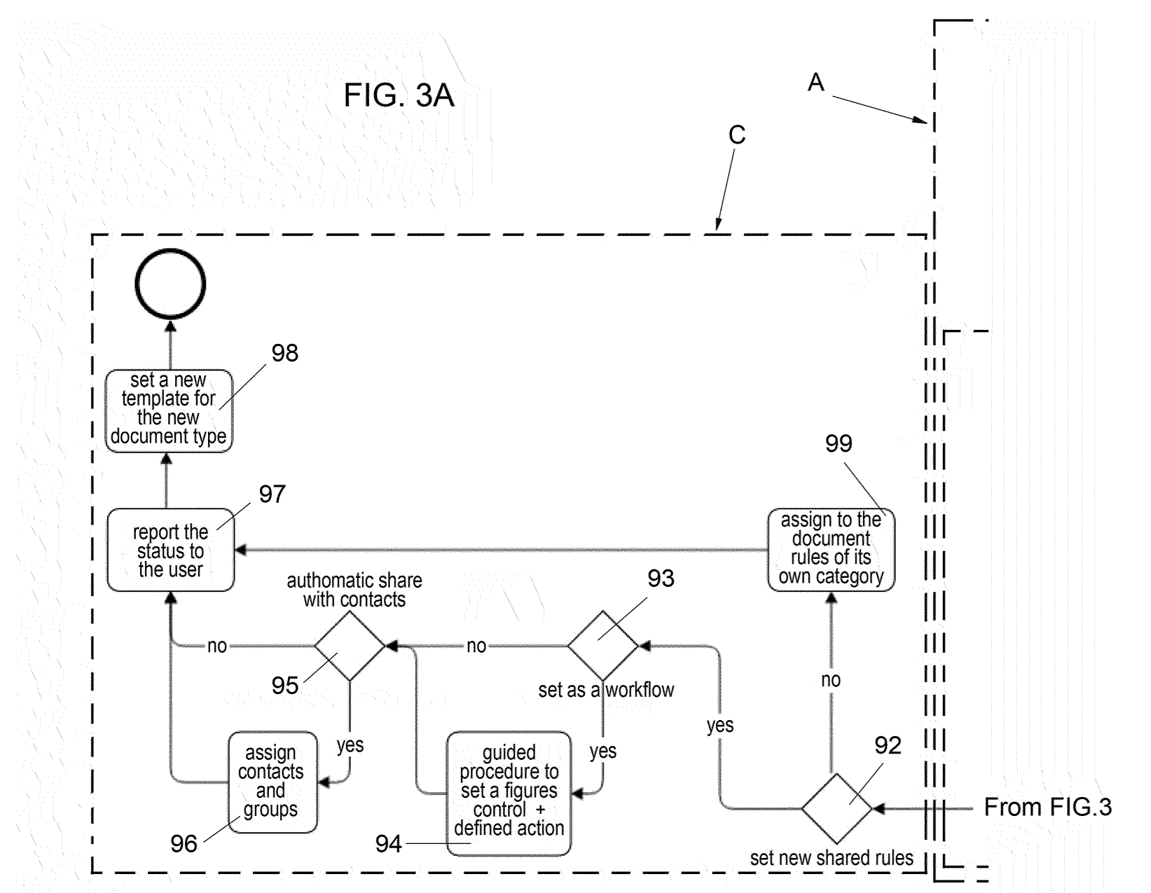

An example of the above described process is well represented in FIGS. 3 and 3A:

Macro-block A: a new document is published in one of the web portals of interest (predefined by the user) and the invention detects (block 80), recognize the document and the document's source (block 81). Finally the document is tagged and archived (block 82).

Macro-block B (sub-block of macro-block A): depending of recognition accuracy (decision block 83), the invention addresses the document to a manual or an automatic archiving process. At this stage, if the document needs a manual procedure, the user intervention makes the invention improve comparison between document and set template, so “learning” the procedure.

If the recognition accuracy is not acceptable, the invention displays information about the document and wait for a user confirmation (block 84) and, if the user decide for a modification of the document (decision block 85), the document is manually tagged (block 86).

If, differently, the recognition accuracy is acceptable, the invention recognizes figures and tag the document (block 87) and, after that, there is another test of quality recognition (decision block 88).

In case the recognition is not acceptable, the invention displays the information and wait for a user confirmation (block 89) and if the user decide (decision block 90) figures tag, it will do it manually (block 91).

At the end, the document is tagged (assigned the search criteria) and archived. (block 82).

Macro-block C: the invention, if required, shares the documents with other predefined users and groups. The successive step is the eventual sharing with pre-defined users. Of course at this stage it is possible to confirm or modify the sharing rules.

More in particular, if required (decision block 92), the invention shares the documents and, if it is desired a setting of a workflow (decision block 93), the invention performs a guided procedure to set figures control with a defined action (block 94) and, if required (decision block 95), automatically shares documents with contacts and assigns contacts and groups (block 96) and, finally, reports the status to the user (block 97) setting a new template for the new document type (block 98).

Differently, in case a sharing of document is not desired, the document will be provided with rules of its own category (block 99) and, then, the status is reported to the user (block 97).

Considering FIG. 2, the next step of this feature (automatic downloading process) allows to run workflow, even for massive number of documents, to share downloaded documents with other users or groups of users.

Specifically, it will be possible to decide to set a workflow (block 71) in order to follow a guided procedure (block 72) to set a figure control or, on the contrary, to allow the user to decide (block 73) for an automatic sharing of documents with the contacts assigning contacts and groups (block 74) or using the application (block 75) without group or contact assigned (FIG. 6).

Referring to the FIG. 2 e-mailing, sharing contents, (i.e. sharing photos (block (76))) etc. can be done selecting the desired function (block 100) proposed by the invention (block and/or accessing to another social Network automatically (authentication procedure done once) (block 101 and block 102).

Referring to the figures, it is clear how the invention can represent an essential opportunity for Companies, Authority Corporations Public Administrations, to have at its disposal a strategic “communication channel” from/to end users (block 77) belonging to the invention community. This bi-directional channel represents the starting point to make the invention a central documents and contents sharing system, regarding all the business, and private, matters.

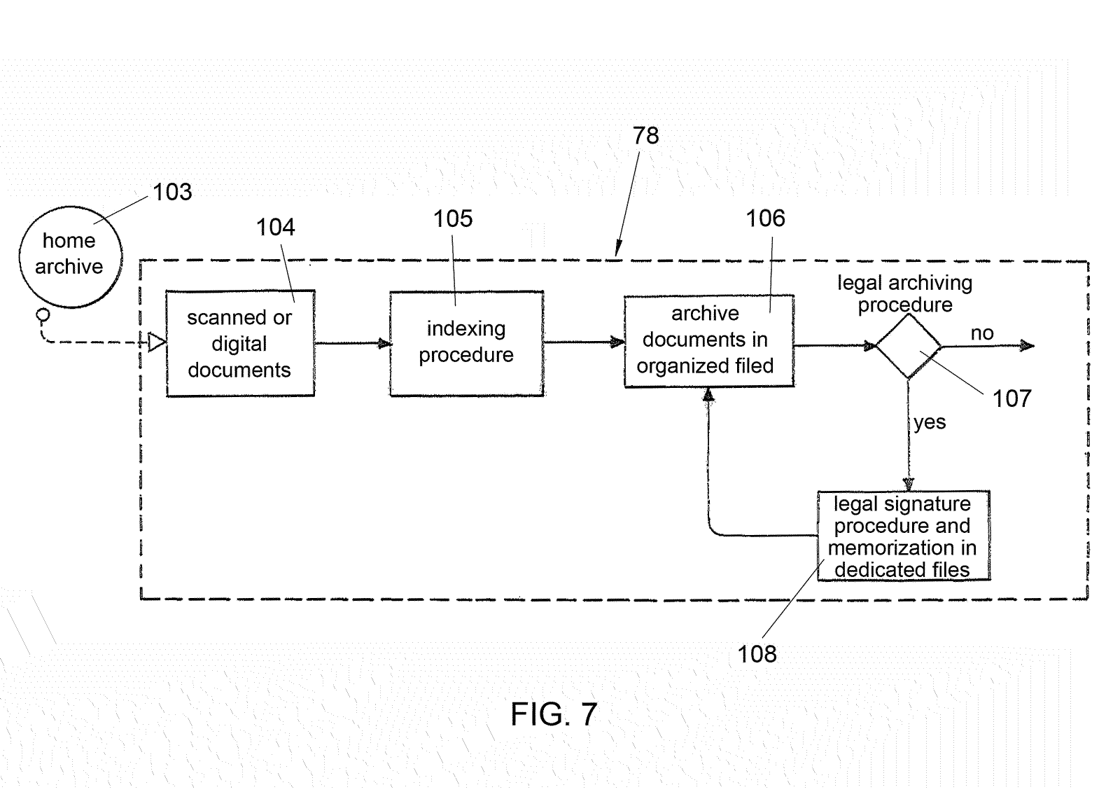

Referring to FIG. 7, the invention will allow also legal document stored procedure (macro-block 78), both to end user (home environment) and business user (i.e. Companies), as complementary step of ECM standard procedures.

More in particular, for example considering an home archive (block 103), a scanned or digital documents (block 104) will be indexed (block 105) and archived in organized files (block 106) and, then, if required (block 107), can be performed a legal archiving procedure for a legal signature procedure and memorization in dedicated files (block 108) for a subsequent archiving of said signed documents in organized files (block 106).

1. A global sharing network system that creates an automated home archive to store different kind of documents, data and contents of social and company networks, the system comprising:
a computing device that executes a scrapping tool automating access and archiving procedures for facilities and services allowing a user to access multiple and different services and sources belonging to locked and secured areas which are accessible following an access/login procedure including presenting permission/identification procedures for manual execution by a user; and
a storage device that memorizes the manually executed permission/identification procedures,
wherein, each time the permission/identification procedures are required, the computing device, in an automatic way, executes the memorized manually executed permission/identification procedures as a unique access procedure for entering all the social and company networks of the user.

2. The global sharing network system according to claim 1, further comprising:
a document storage device,
wherein said scraping tool, i) in memorizing the access/identification procedures and repeating the memorized procedures automatically, provides testing of connections with external computing devices providing external services to verify when each said external connection is already set or not, and ii) in defining the user's document types and the user's documents destination area, manages an automatic downloading process of the user's documents.

3. The global sharing network system according to claim 2, further comprising:
a document storage device operatively connected to the computing device; and
an optical character recognition device operatively connected to the computing device, the optical character recognition device participating in the automatic downloading process of the user's documents to render the user's documents suitable for storage in the document storage device.

4. The global sharing network according to claim 3, wherein said optical character recognition device automatically tags the user's documents.

5. The global sharing network according to claim 3, wherein the user's documents, stored in the document storage device, are marked for sharing with different users.

6. The global sharing network according to claim 1, wherein the computing device is configured to provide a password generation function for use on all memorized procedures.

7. The global sharing network according to claim 1, wherein,
the computing device, in automating access and archiving procedures, presents on a display, a screen with a first selection option of a home environment and a second selection option of a business environment,
the first and second selection options being graphically distinct from each other,
each of the first selection option comprising a container of social functions and the second selection option comprising a container of works functions.

8. The global sharing network according to claim 7, wherein the computing device displays the social and work functions on a dashboard.

9. The global sharing network according to claim 8, wherein said dashboard is customizable by the user.

10. A method for a global sharing network for creating a home archive to store different kind of documents, data and contents of social and company networks, the method comprising:
a computing device executing a scrapping tool providing automated access and archiving procedures for facilities and services allowing a user to access multiple and different services and sources belonging to locked and secured areas which are accessible following an access/login procedure including presenting permission/identification procedures for manual execution by a user;
a storage device memorizing the manually executed permission/identification procedures, wherein, each time the permission/identification procedures are required, the computing device, in an automatic way, executes the memorized manually executed permission/identification procedures as a unique access procedure for entering all the social and company networks of the user,
wherein the user accesses social and company networks by performing only one access secure procedure that executes the stored memorized procedures.

11. The method according to claim 10, further comprising the steps of:
the computing device presenting on a screen a new user registering/login procedure for manual completion by the user;
the computing device providing an optional enabling password generation function on the screen for selection by the user;
the computing device presenting on the screen a first selection option of a home environment and a second selection option of a business environment for selection by the user to choose between the home and business environments;
the computing device guiding the user through a registering procedure for a desired network of selected one of the social and work environments;
the computing device allowing the user, after the registering procedure, to continuing navigation in the entered environment and setting access into another network and ending the navigation/registering procedure.

12. The method according to claim 10, further comprising a step of the computing device providing a guided procedure for establishing new connections for desired external web services of the user and testing predefined connections.

13. The method according to claim 10, comprising the further step of:
the computing device allowing the user to select an automatic downloading and tagging process of a desired document or data from a specified connection; and
when the user selects the automatic downloading and tagging process, the computing device automatically downloading and tagging the desired document or data.

14. The method according to claim 13, comprising the further step of:
the computing device asking the user to follow a guided procedure to set an optical character recognition function and to set a storage destination area for the tagged document or data.

15. The method according to claim 13, comprising the further step of:
the computing device offering the user a selection of automatic sharing of documents or data with other users.
